(19) United States
(12) Patent Application Publication
(10) Pub. No.: US 2011/0132392 A1
(43) Pub. Date: Jun. 9, 2011

(54) Oral Hygienic Facility

(76) Inventor: Jackson Lynn Crisp, Gillette, WY (US)

(21) Appl. No.: 12/687,171

(22) Filed: Jan. 14, 2010

Related U.S. Application Data
(63) Continuation-in-part of application No. 12/592,653, filed on Dec. 1, 2009.
Application No. 12/592,653 is a division of application No. 12/231,274, filed on Sep. 2, 2008, now abandoned.
(60) Provisional application No. 61/133,106, filed on Jun. 25, 2008.

(51) Int. Cl. A61C 15/00

(52) U.S. Cl. 132/309

(57) ABSTRACT

An oral hygienic-utensil comprised of at least one oral hygienic device such as a toothpick, interdental pick, brush, tongue cleaner, dental flossers and/or oral-substance filled containers for personal use after eating in a location where oral hygienic facilities may not be otherwise available. In some embodiments the oral hygienic device may be permanently attached to the hygienic-utensil, which can serve as a gripping surface for using the oral hygienic device. In other embodiments the oral hygienic device may be displaced in a snap-off or bend-away manner at score lines and/or material-hinges to expose the oral hygienic device for use, either still attached to the hygienic-facility or removed for separate use, optionally configured with a thumb-finger grip tab.

### PRIORITY

The present application is a continuation in parts of divisional application Ser. No. 12/592,653, filed Dec. 1, 2009, status pending: divisional application Ser. No. 12/592,653, filed Jan. 26, 2010, status pending and original application Ser. No. 12/231,274, filed Sep. 2, 2008, status pending, claiming priority from provisional application 61/133,106, filed Jun. 25, 2008.

### FIELD OF THE INVENTION

The present invention is in the fields of utensils and hygienic devices, more particularly the invention relates to a utensil that incorporates at least one hygienic component from a group that includes picks, flossers, tongue cleaners, oral brushes and oral product tilled containers.

### BACKGROUND OF THE INVENTION

On the go activity often involves the use of disposable oral-hygienic devices, such as flossers, oral picks, oral brushes, mouthwash, tongue cleaners, typically at away-from-home locations where facilities containing oral-hygienic devices are usually unavailable. Such activity may include planned picnics, picnics-on-the-go, fast food, takeout, lunch boxes, bagged lunches at work, eating-on-the-go, delivered specialties, catered food engagements, entertainment events, birthdays, cocktail-parties, weddings and other engagements.

### DISCUSSION OF KNOWN ART

U.S. design Pat. D254,239 to Julius for a COMBINED FORK AND SEPARATABLE TOOTHPICK shows the ornamental design for the subject matter.

U.S. design Pat. D463,231 to Sanders for EATING UTENSIL WITH TOOTHPICK INCORPORATED THEREIN shows a fork, spoon and knife each with a toothpick located on the front side near the handle end; presumably the toothpick is removably attached in each case.

U.S. Pat. No. 2,877,547 for COMBINATION TOOTHPICK AND STIRRING OR EATING IMPLEMENT to Feaster discloses wooden spoons, forks and stirring sticks configured with knockout-removable toothpicks.

U.S. Pat. No. 2,072,777 to Takahashi for CUTLERY shows a spoon and a fork each with a pair of toothpicks removably attached on the rear side.

U.S. Pat. No. 3,664,020 to Hammond et al for COMBINATION SPOON AND TOOTHPICK shows and discloses a toothpick and spoon combination including a handle portion with a separable toothpick member for use after eating. The combination utilizes support members from which the toothpick may be broken away.

### OBJECTS OF THE INVENTION

It is a primary object of the present invention to provide a disposable plastic hygienic-utensil incorporating an oral-hygienic device such as a straight or curved toothpick, oral brushes, tongue cleaners, dental floss and other oral care products along with one or more optional additional devices for maintaining good oral health at eating events where oral hygiene devices may not be otherwise available

It is a further object to provide snap-off embodiments wherein an oral hygienic device can be user-displaced in a snap-off manner and removed for separate usage, and further, to provide bend-away embodiments wherein a device, permanently attached to a utensil, can be user-displaced in a bend-away manner that exposes the still-attached device, ready for use.

### SUMMARY OF THE INVENTION

The foregoing objects have been met in the present invention wherein a plastic hygienic-utensil is combined with at least one oral-hygienic device that can be molded integrally with the hygienic-utensil. To deploy an oral-hygienic device, one or more score-lines and/or material-hinges configured in the hygienic-utensil enable user displacement of the device and/or selected area of utensil material in a manner to expose the device ready for usage. User-displacement can be implemented in different embodiments as either non-separation bend-away or snap-off separation, depending on design choice and selection of plastic material for resilience, and of score-line/hinge design configuration. An oral hygienic-utensil is now made available for use in locations where oral-hygienic facility items may not be otherwise available.

### BRIEF DESCRIPTION OF THE DRAWINGS

The above and further objects, features and advantages of the present invention will be more fully understood from the following description taken with the accompanying drawings.

FIG. 1 depicts a section front-view of a pick-device of a type straight pick.

FIG. 2 depicts a section front-view of a pick-device of a type curved-pick.

FIG. 3 depicts a section front-view of a pick-device of a type double-headed pick.

FIG. 4 depicts a section front-view of a pick-device of a type interdental-pick.

FIG. 5 depicts a section front-view of a pick-device of a type interdental-brush.

FIG. 6 depicts a section front-view of a utensil-portion configured with a pick-device and a pick-device related bend-away portion of protective utensil-portion material.

FIG. 7 depicts a section front-view of a utensil-portion configured with a tabbed pick-device that can be un-snapped and bent away for deployment and then bent back and re-snapped back into initial position for storage.

FIG. 8 depicts a section front-view of a utensil-portion configured as an end-cap.

FIG. 9 depicts a section front-view of a utensil-portion configured with a pick-device attachment region, centrally located and vertically oriented.

FIG. 10 depicts a section front-view of a utensil-portion configured with an upward angled pick-device.

FIG. 11 depicts a section front-view of a utensil-portion configured with two pick-devices, both oriented at an upward angle.

FIG. 12 depicts a section front-view of a utensil-portion configured with a pick-device oriented horizontally.

FIG. 13 depicts a section front-view of a utensil-portion configured with two pick-devices, both oriented horizontally.

FIG. 14 depicts a section front-view of a utensil-portion configured with three pick-devices, the first being centrally located and oriented vertically and the remaining two being oriented horizontally.

FIG. 15 depicts a section front-view of a utensil-portion configured with two pick-devices, the first being centrally located and oriented vertically and the remaining two being oriented horizontally.

FIG. 16 depicts a section front-view of a utensil-portion incorporated with a substance filled burstable container.

FIG. 17 depicts a front view of FIG. 16 burstable container.

FIG. 18 depicts a section side-view of FIG. 16 utensil-portion incorporated with a substance filled burstable container.

FIG. 19 depicts a section front-view of a utensil-portion incorporated with a substance filled burstable container and a horizontally oriented pick-device.

FIG. 20 depicts a section front-view of a utensil-portion incorporated with a substance filled burstable container and two horizontally oriented pick-devices.

FIG. 21 depicts a section front-view of a utensil-portion configured as a tongue cleaner.

FIG. 22 depicts a section front-view of utensil-portion incorporated with an indented brush pad reference for placement feature.

FIG. 23 depicts a section assembly side-view of a brushing pad being integrally applied to FIG. 22 utensil-portion.

FIG. 24 depicts a section side-view of a brushing pad assembled FIG. 23 utensil-portion.

FIG. 25 depicts a section side-view of utensil-portion configured with a ridged tongue cleaner and brushing pad.

FIG. 26 depicts a section side-view of utensil-portion configured with a bristle brush and brushing pad.

FIG. 27 depicts a section side-view of utensil-portion configured with a ridged tongue cleaner and bristle brush.

FIG. 28 depicts a section front-view of a utensil-portion configured as a ridged tongue cleaner.

FIG. 29 depicts a section front-view of a utensil-portion configured with a bristle brush.

FIG. 30 depicts a section front-view of utensil-portion configured with a flosser and a pick-sheath.

FIG. 31 depicts a cutaway back-view of FIG. 30 utensil-portion showing tooling undercut areas used to form the pick sheath containment tabs.

FIG. 32 depicts a section front-view of FIG. 30 utensil-portion configured with a flosser and a sheathed toothpick.

FIG. 33 depicts a section front-view of a FIG. 30 compatible pick-device.

FIG. 34 depicts a cutaway side-view of FIG. 33 pick-device.

FIG. 35 depicts a cutaway back view of FIG. 33 pick-device.

FIG. 36 depicts a section front-view of a utensil-portion configured with a pick-sheath.

FIG. 37 depicts a cutaway back view of FIG. 36 utensil-portion showing tooling undercut areas used to form pick-sheath containment tabs.

FIG. 38 depicts a section front-view of FIG. 36 utensil-portion configured with a sheathed toothpick.

FIG. 39 depicts a section front-view of a FIGS. 36 and 43 compatible pick-device.

FIG. 40 depicts a cutaway back-view of FIG. 39 pick-device.

FIG. 41 depicts a cutaway side-view of FIG. 39 pick-device.

FIG. 42 depicts a detail-view of one FIG. 39 capture/slide snap-feature.

FIG. 43 depicts a section front-view of utensil-portion configured with a pick-sheath.

FIG. 44 depicts a cutaway back view of FIG. 43 utensil-portion showing the FIG. 42 snap-feature related slide surface.

FIG. 45 depicts a section front-view of a utensil-portion configured with a sheathed toothpick, toothpick shown at a position-a.

FIG. 46 depicts a section front-view of a utensil-portion configured with a sheathed toothpick, toothpick shown at a position-b.

FIG. 47 depicts a section front-view of a utensil-portion configured with a sheathed toothpick and a horizontally oriented pick-device.

FIG. 48 depicts a section front-view of a utensil-portion configured with a sheathed toothpick and a horizontally oriented pick-device.

FIG. 49 depicts a section front-view of a utensil-portion configured with a sheathed toothpick and two horizontally oriented pick-devices.

FIG. 50 depicts a section front-view of a utensil-portion configured with a sheathed toothpick and two horizontally oriented pick-devices.

FIG. 51 depicts a section front-view of a utensil-portion configured with an angled horizontal-flosser and a sheathed toothpick.

FIG. 52 depicts a section front-view of a utensil-portion configured with an angled horizontal-flosser and a sheathed toothpick constraint loaded in a pick-sheath.

FIG. 53 depicts a section front-view of a utensil-portion configured as an angled horizontal-flosser.

FIG. 54 depicts a section side-view of FIG. 53 utensil-portion configured as an angled horizontal-flosser.

FIG. 55 depicts a section front-view of a utensil-portion configured as a horizontal-flosser.

FIG. 56 depicts a section front-view of a utensil-portion configured with a horizontal-flosser and a displaceably attached pick-device.

FIG. 57 depicts a section front-view of utensil-portion configured with an angled horizontal-flosser and a displaceably attached pick-device.

FIG. 58 depicts a section side-view of FIG. 57 utensil-portion configured with an angled horizontal-flosser and displaceably attached pick-device.

FIG. 59 depicts a section front-view of a utensil-portion configured with an angled horizontal-flosser and a (rotational energy capture) displaceably attached pick-device.

FIG. 60 depicts a section front-view of a utensil-portion configured as an angled-flosser.

FIG. 61 depicts a section front-view of a utensil-portion configured as a fork.

FIG. 62 depicts a section front-view of a utensil-portion configured as a knife.

FIG. 63 depicts a section front-view of a utensil-portion configured as a spoon.

FIG. 64 depicts a section front-view of a utensil-portion configured as a spork.

FIG. 65 depicts a section front-view of a utensil-portion configured as a stirring-rod which can double as a handle.

FIG. 66 depicts a section front-view of a utensil-portion configured with a top-section that can be bent-away relative to a bottom-section.

FIG. 67 depicts a section front-view of a utensil-portion configured with a top-section that is score-line separated from a bottom-section, top-section initially configured with a fully guarded pick-device.

FIG. 68 depicts a section front-view of a utensil-portion configured with a top-section that can be bent-away relative to a bottom-section, bottom-section configured with a fully guarded pick-device.

FIG. 69 depicts a section front-view of a utensil-portion configured with a top-section that is score-line separated from a bottom-section, top-section configured with a partially guarded pick-device.

FIG. 70 depicts a section front-view of a utensil-portion configured with a partially guarded and displaceable pick-device.

FIG. 71 depicts a section front-view of a utensil-portion configured with a fully guarded and displaceable pick-device.

FIG. 72 depicts a section front-view of a utensil-portion configured with a fully guarded and displaceable pick-device.

FIG. 73 depicts a section front-view of a utensil-portion configured with a fully guarded and displaceable double-sided pick-device.

FIG. 74 depicts a section front-view of a utensil-portion configured with a fully guarded and displaceable tabbed double-sided pick-device.

FIG. 75 depicts a section front-view of a utensil-portion configured with a fully guarded and displaceable tabbed pick-device.

FIG. 76 depicts a section front-view of a utensil-portion configured with a fully guarded and double-sided score-line displaceable tabbed pick-device.

FIG. 77 depicts a section front-view of a utensil-portion configured with a fully guarded and displaceable pick-device.

FIG. 78 depicts a section front-view of a utensil-portion configured with a fully guarded and displaceable tabbed pick-device.

FIG. 79 depicts a section front-view of a utensil-portion configured with a snap-away burstable container.

FIG. 80 depicts a section front-view of a utensil-portion configured as a vertical-flosser.

FIG. 81 depicts a section front-view of a utensil-portion configured with a vertical-flosser and a tabbed pick-device, tab located and displaceably attached in the flosser opening.

FIG. 82 depicts a section front-view of a utensil-portion configured with a displaceable vertical-flosser.

FIG. 83 depicts a section front-view of a utensil-portion configured with a top-segment that is score-line separated from a bottom-segment.

FIG. 84 depicts a section side-view of a utensil-portion configured with a permanent bend.

FIG. 85 depicts a section side-view of a utensil-portion configured with two permanent bends.

FIG. 86 depicts a cut-away side-view of a score-line design with the separated segments located at a position-a.

FIG. 87 depicts a cut-away side-view of FIG. 86 score-line design with the separated segments located at a position-b.

FIG. 88 depicts a cut-away side-view of a score-line design with the separated segments located at a position-a.

FIG. 89 depicts a cut-away side-view of FIG. 86 score-line design with the separated segments located at a position-b.

FIG. 90 depicts a section front-view of a (plain) utensil-panel.

FIG. 91 depicts a front-view of a utensil-panel embedded with a utensil-portion displaceable pick-device and a utensil-portion displaceably vertical-flosser device, devices in an initial or secure position.

FIG. 92 depicts a front-view of FIG. 91 utensil-panel where both the pick-device and vertical-flosser device are in a deployed or open-position.

FIG. 93 depicts a front-view of two vertically oriented and displaceably attached FIG. 91 utensil-panels.

FIG. 95 depicts a front-view of two horizontally oriented and displaceably attached FIG. 91 utensil-panels.

FIG. 95 depicts a section front-view of FIG. 91 similar utensil-panel.

FIG. 96 depicts an exploded section-assembly front-view of six utensil-portions being section-matched (combined) into a single (eating oriented) hygienic-utensil.

FIG. 97 depicts an exploded section-assembly front-view of five utensil-portions being section-matched into a single (eating oriented) hygienic-utensil.

FIG. 98 depicts an exploded section-assembly front-view of four utensil-portions being section-matched into a single (eating oriented) hygienic-utensil.

FIG. 99 depicts an exploded section-assembly front-view of three utensil-portions being section-matched into a single (oral-hygiene oriented) hygienic-utensil.

FIG. 100 depicts an exploded section-assembly front-view of three utensil-portions being section-matched into a single (eating oriented) hygienic-utensil.

FIG. 101 depicts an exploded section-assembly front-view of three utensil-portions being section-matched into a single (eating oriented) hygienic-utensil and a utensil-panel embedded with two utensil-portions, one of utensil-portions is being section-matched with an interdental-pick.

FIG. 102 depicts a front-view of a utensil-panel configured with an internally attached (eating oriented) hygienic-utensil; one internally and removably attached utensil-portion of a type burstable container; and one embedded utensil-portion of a type displaceable toothpick.

FIG. 103 depicts a front-view of FIG. 96 section-matched hygienic-utensil configured with two picks and a displaceable interdental-brush.

FIG. 104 depicts a front-view of FIG. 103 section-matched hygienic-utensil with the interdental-brush (bend-away) deployed and ready for use.

FIG. 105 depicts a front-view of FIG. 97 section-matched hygienic-utensil configured with a displaceable pick/interdental-brush hygienic-device.

FIG. 106 depicts a front-view of FIG. 98 section-matched hygienic-utensil configured with a horizontal-flosser and a displaceable interdental-pick.

FIG. 107 depicts a front-view of FIG. 106 section-matched hygienic-utensil with the interdental-pick (bend-away) deployed for use.

FIG. 108 depicts a front-view of FIG. 100 section-matched (eating oriented) hygienic-utensil configured with a vertical-flosser.

FIG. 109 depicts a front-view of FIG. 101 section-matched (eating oriented) hygienic-utensil configured with a displaceable utensil-panel; utensil-panel configured with a displaceable pick and flosser.

FIG. 110 depicts an exploded section-assembly front-view of four utensil-portions being section-matched into a single (eating oriented) hygienic-utensil.

FIG. 111 depicts an exploded section-assembly front-view of four utensil-portions being section-matched into a single (eating oriented) hygienic-utensil.

FIG. 112 depicts a front-view of FIG. 110 section-matched hygienic-utensil configured with a displaceable pick.

FIG. 113 depicts a front-view of FIG. 112 section-matched hygienic-utensil with the displaceable pick (bend-away) deployed and ready for use.

FIG. 114 depicts a front-view of FIG. 111 section-matched hygienic-utensil configured with a displaceable angled-flosser/interdental-brush hygienic device.

FIG. 115 depicts a front-view of FIG. 113 section-matched hygienic-utensil with hygienic device (bend-away) deployed exposing the interdental-brush and ready for use.

FIG. 116 depicts a front-view of a section-matched (eating oriented) hygienic-utensil configured with an oral-rinse filled bustable pouch.

FIG. 117 depicts a front-view of a section-matched (eating oriented) hygienic-utensil configured with a sheath pick.

FIG. 118 depicts a front-view of a section-matched (eating oriented) hygienic-utensil configured with an angled-flosser.

FIG. 119 depicts a front-view of a section-matched (eating oriented) hygienic-utensil configured with an angled-flosser.

FIG. 120 depicts a front-view of a section-matched (eating oriented) hygienic-utensil configured with a horizontal-flosser.

FIG. 121 depicts a front-view of a section-matched (eating oriented) hygienic-utensil configured with a (ridged) tongue-cleaner and vertical-flosser.

FIG. 122 depicts a front-view of a section-matched (eating oriented) hygienic-utensil configured with a pick, pick being guarded by displaceable and protective hygienic-utensil material.

FIG. 123 depicts a front-view of FIG. 122 section-matched (eating oriented) hygienic-utensil with the protective hygienic-utensil material displaced and the pick exposed ready for use.

FIG. 124 depicts a top isometric-view of a commercially ready FIG. 112 design.

FIG. 125 depicts a bottom isometric-view of FIG. 124 (eating oriented) hygienic-utensil.

FIG. 126 depicts a top isometric-view of a commercially ready FIG. 113 design.

FIG. 127 depicts a bottom isometric-view of FIG. 126 (eating oriented) hygienic-utensil.

FIG. 128 depicts a front-view of a section-matched hygienic-utensil configured with a displaceable interdental-brush.

FIG. 129 depicts a front-view of FIG. 128 section-matched hygienic-utensil with the interdental-brush (bend-away) deployed for use.

FIG. 130 depicts a front-view of a section-matched hygienic-utensil configured with a displaceable interdental-brush and interdental-pick.

FIG. 131 depicts a front-view of FIG. 130 section-matched hygienic-utensil with the interdental-pick (bend-away) deployed for use.

FIG. 132 depicts a front-view of a section-matched hygienic-utensil configured with a horizontal-flosser and a displaceable pick.

FIG. 133 depicts a front-view of FIG. 132 section-matched hygienic-utensil with the pick (bend-away) deployed for use.

FIG. 134 depicts a front-view of a section-matched hygienic-utensil configured with a displaceable interdental-brush.

FIG. 135 depicts a front-view of FIG. 134 section-matched hygienic-utensil with the interdental-brush (bend-away) deployed for use.

### DETAILED DESCRIPTION

The utensil-portions depicted in the following figures can be section-matched to one another at any of the figure identified section-line locations. Utensil-portions can be section-matched in flipped and/or skewed (in reference to section-line) orientations. A hygienic-utensil is any utensil-portion and/or multiple section-matched utensil-portions configured with at least one device i.e. a tongue-cleaner, toothpick, interdental-pick, interdental-brush, oral-brush, flosser, container, spoon, fork, knife, spork, other device and/or combinations thereof. Many novel and helpful hygienic-utensils are created by interchangeably section-matching the various utensil-portions as defined in this specification. A hygienic-utensil can be displaceably and/or permanently attached to other hygienic-utensils.

In the figures as defined throughout this specification the hygienic-utensil elements separated by at least one score-line can be displaced by a snap-away method, bend-away method and/or a combination thereof, with displacement occurring about the score-line also referred to as the hinge region. In a method by which elements are snap-away separated at the score-line, score-line material is relatively brittle with the depth of the score-line chosen to make snap-off easy and convenient, however in special embodiments that require initial stiffness, the score-line is made shallower, requiring greater force for snap-off separation. In a method by which elements are bent-away displaced about the score-line, a score-line material is made relatively resilient so as to allow bend-away (as opposed to snap-off) of score-line separated elements, a score-line made and arranged in different manners so as to allow for bend-away of the score-line separated elements to various degrees, utilizing varying bend-away or radial forces (including recovery forces or the threes internal to the score-line material that are available to return bent-away element back to a near initial position). In a method by which elements are bent-away and/or snapped-away the score-line and associated material is made and arranged so as to allow for bend-away when a radial-force is applied and snap-away when a (design-limit) tensile-force (relatively) perpendicular to score-line is applied. Score-line i.e. lines in which the basic handle strength is reduced locally e.g. by slots, V-grooves, perforations, embossing, etc., configured on one or both sides of any applicable utensil-portion, as defined in this specification, have the effect of reducing material thickness and thus reduced strength along the score line(s). Score-lines in combination with the appropriate utensil-portion material can be designed to function as a living hinges, living hinges which can vary in type, function and design. When a score-line is referenced in the following figures descriptions it is to be understood that any one of the previously defined and applicable score-line designs can (or could) be utilized unless otherwise specifically stated.

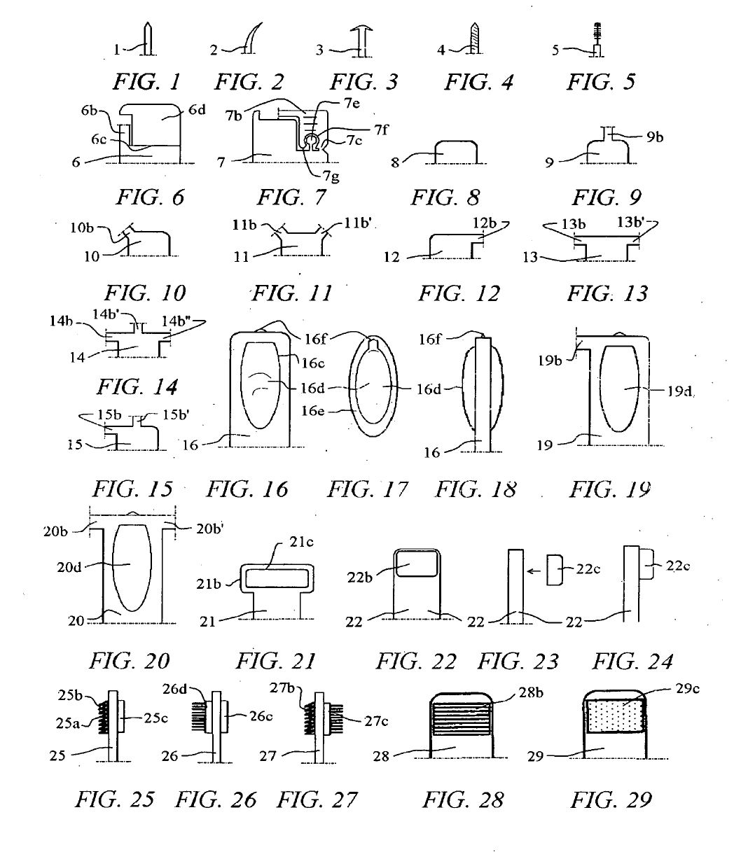

In the following figure descriptions, each Any one of the pick-device depicted in FIGS. 1-5 can be sectioned-matched with any one of the applicable utensil-portions at the utensil-portion related and depicted pick-device section-line location. Any one pick-device can also be section-matched to any one utensil-portion related section-line locations.

FIG. 1 is a section front-view of a pick-device 1 configured as a pick (also referred to as a toothpick).

FIG. 2 is a section front-view of a pick-device 2 configured as a curved-pick (also referred to as a curved-toothpick).

FIG. 3 is a section front-view of a pick-device 3 configured as a split-pick.

FIG. 4 is a section front-view of a pick-device 4 configured as an interdental-pick.

FIG. 5 is a section front-view of a pick-device 5 configured as an interdental-brush. The shaft shown as being integrally formed as a part of interdental-brush 5 can be made of plastic, steel, any other applicable material and/or combinations thereof; said shaft can range in stiffness and type from flexible, bendable or rigid; shaft is preferably mold incorporated into the hygienic-utensil/utensil-portion).

FIG. 6 is a section front-view of utensil-portion 6 configured with pick-device 6b, pick-device 6b is protected on one side by an adjacent guard tab 6d that is made user-displaceable at score-line 6c so as to expose pick-device 6b. Guard tab 6d can vary in shape, location and score-line configuration, depending on the location and type of pick-device 6b being guarded. This displaceable guard concept can be used in part or in total on any of FIGS. 9-15, 19-20 and 47-50 utensil-portion designs.

FIG. 7 is a section front-view of utensil-portion 7 configured with a tabbed pick-device 7b. Pick device 7b can be snap-released for use; snap receptacle 7f being snap-away released from post 7e; pick-device 713 pivoting about hinge material 7c, exposing pick-device 7b for deployment. After deployment pick-device 7b can then be stored by snap-secure method, a method by where leading edge 7g engages post 7e allowing snap receptacle 7f to snap-fit engage post 7e, securing pick-device 7b. Snap post 7e and snap receptacle 7f can be integrated in different utensil-portion 7 locations without departing from the snap-to release and snap-to secure functionality. FIG. 7 is novel in the fact that it can be molded as a single part, snap post, snap receptacle, hinge features and all; making utensil-portion 7 a practical design that can be incorporated into a variety of plastic parts.

FIG. 8 is a section front-view of utensil-portion 8 configured as a utensil-portion end cap.

FIG. 9 is a section front-view of utensil-portion 9 configured with a vertical oriented pick-device 9b.

FIG. 10 is a section front-view of utensil-portion 10 configured with an angled pick-device 10b.

FIG. 11 is a section front-view of utensil-portion 11 configured with two angled pick-devices 11b and 11b′.

FIG. 12 is a section front-view of utensil-portion 12 configured with a horizontal oriented pick-device 12b.

FIG. 13 is a section front-view of utensil-portion 13 configured with two horizontal oriented pick-devices 13b and 13b′.

FIG. 14 is a section front-view of utensil-portion 14 configured with two horizontal and one vertical oriented pick-devices 14b, 14b′ and 14b″.

FIG. 15 is a section front-view of utensil-portion 15 configured with one horizontal oriented and one vertically oriented pick-devices 15b and 15b′.

FIG. 16 is a section front-view of utensil-portion 16 configured with a mold integrated burstable container 16d, burstable container 16d is mold incorporated into utensil-portion 16 about FIG. 17 sealed portion 16e at mold interface region 16c. To deploy a user squeezes bustable container 16d thus bursting the container sealed opening 16f thereby releasing container substance 16g, substance 16g preferably being a oral rinse agent and directly released into user mouth. Burstable container 16d is generally intended for one time use. A utensil-portion 16 design can be incorporated configured in such a way as to allow a user to break-out/off a used burstable container 16d while preferably leaving the remaining utensil-portion 16 in tact.

FIG. 17 is a front-view of FIG. 16 burstable container 16d configured with a sealed portion 16e, sealed portion 16e made relatively weak at seal opening 16f so as to focus the container exhausted substance 16g through burstable sealed opening 16f upon burstable container 16d user squeezing/bursting action. Burstable container 16d can be sold as a standalone product.

FIG. 18 is a section side-view of FIG. 16 utensil-portion 16 configured with burstable-container 16d.

FIG. 19 is a section front-view of utensil-portion 19 configured with a burstable container 19d similar to FIG. 16 and horizontal oriented pick-device 19b.

FIG. 20 is a section front-view of utensil-portion 20 configured with a burstable container 20d similar to FIG. 16 further including two horizontal oriented pick-devices 20b and 20b′.

FIG. 21 is a section front-view of utensil-portion 21 configured with a (standard design) tongue cleaner 21b complete with scraping edge 21c. Utensil-portion 21 can fluffier be configured to accommodate an oral brush.

FIG. 22 is a section front-view of utensil-portion 22 configured with an indented reference feature 22b, reference feature 22b allowing for accurate placement of FIG. 23 assembled brushing pad 22c, reference feature 22b is optional.

FIG. 23 is a section assembly front-view of FIG. 22 utensil-portion 22 with brushing-pad 22c being applied to FIG. 22 reference feature 22b defined area. In a utensil-portion 22 embodiment where reference feature 22b is omitted, brushing-pad 22c would be integrally and directly applied to end-portion 22.

FIG. 24 is a section front-view of assembled FIG. 23 utensil-portion 22.

FIG. 25 is a section side-view of utensil-portion 25 configured with a (ridged) tongue cleaner 25b and a brushing pad 25c with tongue cleaner 25b containing multiple scraping ridges 25a.

FIG. 26 is a section side-view of utensil-portion 26 configured with a (oral brush) bristle-brush 26d and a brushing pad 26c.

FIG. 27 is a section side-view of utensil-portion 27 configured with a (oral-brush) bristle-brush 27d and a FIG. 25 similar (ridged) tongue cleaner 27c.

FIG. 28 is a section front-view of utensil-portion 28 configured as a FIG. 25 similar (ridged) tongue cleaner.

FIG. 29 is a section front-view of utensil-portion 29 configured with a (oral brush) bristle-brush 29c.

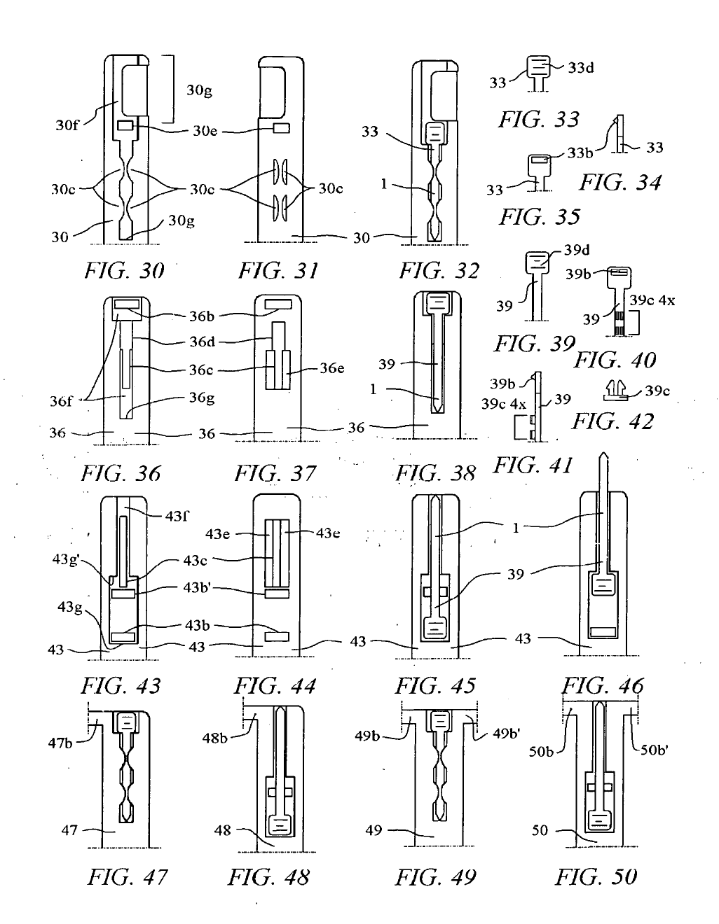

FIG. 30 is a section front-view of utensil-portion 30 configured with vertical-flosser 30g and sheath elements: containment-tabs 30c, surface 30f and backstop 30g. When FIG. 33 pick-device 33 is sheathed FIG. 34 snap-bump 33b snaps into slot 30e, securing pick-device 33 to sheath. In an alternative embodiment flosser 30g is omitted. In another embodiment snap-bump 33b and slot 30e are omitted and pick-device 33 is manufactured with a natural and permanent slight curvature (bow) which provides a pick-device 33 to sheath components friction, friction keeping pick-device 33 secured in sheath. Containment-tabs 30c and surface 30f can be contoured as needed to accommodate different pick-device 33 designs. Utensil-portion 30 can be made from a two-part mold (with no slide pins).

FIG. 31 is a section back-view of FIG. 30 utensil-portion 30 and shows the containment-tabs 30c (formed by undercut tooling) and slot 30e.

FIG. 32 is a section front-view of FIG. 30 utensil-portion 30 including sheathed pick-device 33, pick-device 33 is section-matched with FIG. 1 pick-device 1.

FIG. 33 is a section front-view of pick-device 33.

FIG. 34 is a section side-view of FIG. 33 pick-device 33 configured with snap-bump 33b. Snap bump 33b is designed as such, i.e. tapered, as to allow for simple disengagement of slots upon horizontal forces applied to tab-grip 33d.

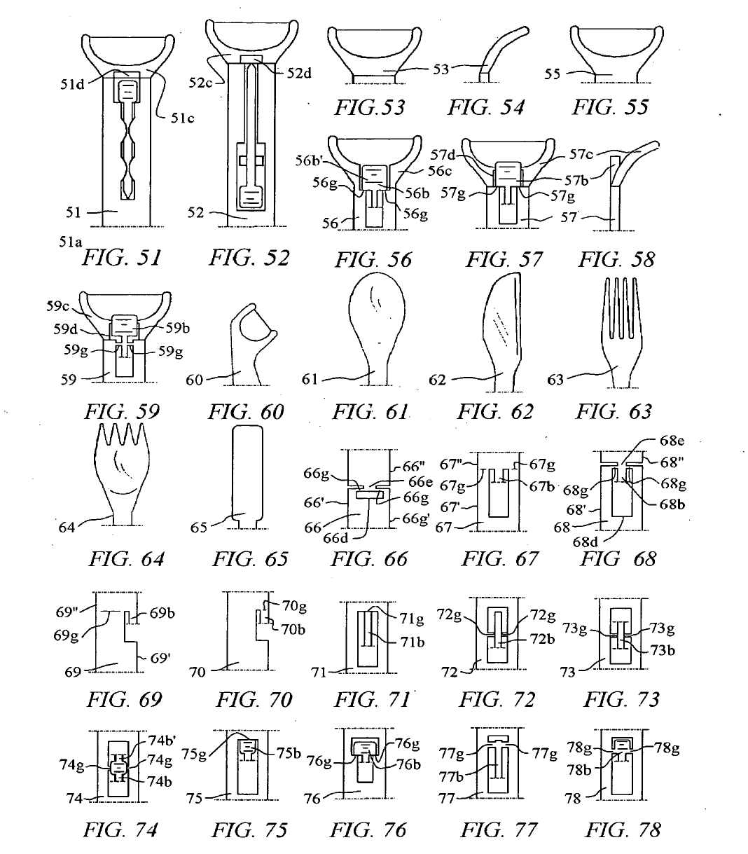

FIG. 35 is a section back-view of pick-device 33 configured with snap-bump 33b.

FIG. 36 is a section front-view of utensil-portion 36 configured with sheath elements: surface 36f, access-opening 36d, slide opening 36c, backstop 36g and FIG. 37 slide track 36e. In sheathing FIG. 39 pick-device 39 the FIG. 40 slide-features 39c are initially inserted through access-opening 36d and as pick-device 39 is slid towards backstop 36g the slide features 39c engage slide opening 36c capturing slide features 39c between surface 36f and slide track 36e; as pick-device 39 is continually slid towards back stop 36g FIG. 40 snap bump 39b engagingly snaps into slot 36e, securing pick-device 39 to utensil-portion 36, see supporting FIGS. 36-38. The numbers and positioning of pick-device 39 configured slide features 39c can vary. In yet another embodiment snap-bump 39b and slot 36e are omitted and pick-device 39 is manufactured with a bow as described in FIG. 30. Surface 36f can be contoured as such to accommodate a variety of pick-device 39 designs. This design can be made thin and does not involve complicated tooling for fabrication.

FIG. 37 is a section back-view of FIG. 36 utensil-portion 36 further showing slide track 36e.

FIG. 38 is a section front-view of FIG. 36 utensil-portion 36 including sheathed pick-device 39, pick-device 39 is section-matched with FIG. 1 pick-device 1. When removing pick-device 39 a user would apply a horizontal force to pick-device 39 configured tab-grip 39d so as to disengaging snap-bump 39b thus beginning to un-sheath pick-device 39 until slide-features 39c clear access opening 36d, at which point pick-device 39 can be removed for deployment.

FIG. 39 is a section front-view of a FIGS. 36 and 42 utensil-portion compatible pick-device 39.

FIG. 40 is a section back-view of FIG. 39 pick-device 39 configured with four slide features 39c and snap-bump 39b. Snap bump 39b can be tapered to allow for simple disengagement of slots upon horizontal forces being applied to tab-grip 39d.

FIG. 41 is a section side-view of FIG. 39 pick-device 39 configured with four slide features 39c and snap-bump 33b.

FIG. 42 is a detail-view of a single pick-device 39 configured slide feature 39c.

FIG. 43 is a section front-view of utensil-portion 43 configured with sheath elements: surface 43f, slide opening 43c, position-1 stop 43g, position-2 stop 43g′ and FIG. 44 slide track 43e. In sheathing FIG. 39 pick-device 39 FIG. 40 slide-features 39c are initially snap-fit inserted through slide opening 43c instantly capturing slide features 39c between surface 43f and slide track 43e; as FIG. 39 pick-device 39 is slid back-and-forth between position-1 stop 43g and position-2 stop 43g′ FIG. 40 pick-device 39 configured snap bump 39b engagingly snaps into each corresponding position-1 slot 43b and position-2 slot 43b′. The count and position of slide features 39c can vary. Alternatively snap-bump 39b, position-1 slot 36b and position-2 slot 36b′ can be omitted with pick-device 39 being manufactured with a bow as described in FIG. 30. Surface 43f can be contoured as such to accommodate different pick-device 39 designs and/or other attached devices.

FIG. 44 is a section back-view of FIG. 43 utensil-portion 43 further showing slide track 43e.

FIG. 45 is a section front-view of FIG. 43 utensil-portion 43 configured with sheathed pick-device 39, pick-device 39 is section-matched with FIG. 1 pick-device 1.

FIG. 46 is a section front-view of FIG. 43 utensil-portion 43 configured with sheathed pick-device 39, pick-device 39 is section-matched with FIG. 1 pick-device 1, pick-device 39 is deployed to a ready-for-use position.

FIG. 47 is a section front-view of utensil-portion 47 configured with sheath similar to that depicted in FIG. 30 and a horizontal oriented pick-device 47b.

FIG. 48 is a section front-view of utensil-portion 48 configured with sheath similar to that depicted in FIG. 43 but further comprising a horizontal oriented pick-device 48b. Utensil-portion 48 can also be configured with FIG. 38 sheath design.

FIG. 49 is a section front-view of utensil-portion 49 configured with sheath similar to that depicted in FIG. 30 and two horizontal oriented pick-devices 49b and 49b′.

FIG. 50 is a section front-view of utensil-portion 50 configured with sheath similar to that depicted in FIG. 43 and two horizontally oriented pick-devices 50b and 50b′. Utensil-portion 50 can be configured with FIG. 38 sheath design.

FIG. 51 is a section front-view of utensil-portion 51 configured with sheath similar to that depicted in FIG. 30 and a FIG. 53 similar angled horizontal-flosser 51c. Angled horizontal-flosser 51c configured with a removed material feature 51d, allowing for uninhibited removal of depicted sheathed pick-device.

FIG. 52 is a section front-view of utensil-portion 52 configured with sheath similar to that depicted in FIG. 43 and a FIG. 53 similar angled horizontal-flosser 52c. Angled horizontal-flosser 52c configured with a removed material feature 52d, allowing for un-inhibited deployment of sheathed pick-device.

FIG. 53 is a section front-view of utensil-portion configured as an angled horizontal-flosser 53.

FIG. 54 is a section side-view of FIG. 53 utensil-portion configured as an angled horizontal-flosser 53.

FIG. 55 is a section front-view of utensil-portion 55 configured as a horizontal-flosser 53.

FIG. 56 is a section front-view of utensil-portion 56 configured with a horizontal-flosser 56 and pick-device 56b, pick-device 56b configured with a tab-grip 56b′ and displaceably attached at score-lines 56g. In a bend-away embodiment, tab-grip 56b′ can be bent-back thusly exposing pick-device 56b for use, this concept/functionality works in a similar fashion for FIGS. 57-59 and 67-78.

FIG. 57 is a section front-view of utensil-portion 57 configured with an angled horizontal-flosser 57c and a pick-device 57b, pick-device 57b configured with a tab-grip and displaceably attached at score-lines 57g. Clearance area 57d allowing for clearance of pick-device 57b configured tab-grip upon bend-away deployment of pick-device 57b while still attached to end-portion 57. In an alternative embodiment pick-device 57b and associated score-lines 57g location (including pick-device guard area) can be lowered so that the pick-device 57b related tab-grip top is at the same level or lower then the flosser 57c bend location; thus allowing for better stack-ability potential. In FIGS. 56-59 the angled horizontal-flosser can be configured with a sharper angle (curved) bend so as to enhance access to bend-way deployed pick-device.

FIG. 58 is a section side-view of FIG. 57 utensil-portion 57 configured with an angled horizontal-flosser 57c and pick-device 57b.

FIG. 59 is a section front-view of utensil-portion 59 configured with an angled horizontal-flosser 59c (similar to FIG. 57) and a pick-device 59b, pick-device 59b configured with a tab-grip and is displaceably attached at material hinges 59g. Material hinges 59g are made and arranged to allow for bend-away of pick-device 59b (similar to bend-away described in FIG. 57) during which material hinges 59g are rotationally twisted, storing rotational energy, stored rotational energy used to return pick-device back to the original and protected position upon pick-device 59b being release by the user. Clearance area 59d allows for clearance of pick-device 59b configured tab-grip upon bend-away deployment of pick-device 59b while still attached to end-portion 59. The rotational stored energy achieved by the twisting action about material hinges 59g can be increased or decreased based on the physical characteristics and material makeup of material hinges 59g i.e. if the cross-sectional thickness of material used to form material hinges 59g is made thicker (given the material elasticity remains constant and sufficient as to allow for pre-defined bend-away ranges of pick-device 59b with out reaching failure point) the (potential) rotational energy would be increased thus allowing for more (kinetic) rotational energy, in a bend-away state, for returning pick-device 59b back to an original or near original position upon user release of a deployed pick-device 59b. Rotational-energy as depicted in FIG. 59 could have greater advantages in regards to creating more (potential and kinetic) energy for returning pick-device 59b back to an original position versus the energy created when a device is bent-away about a score-line. Similar to FIG. 57 Pick-device 59b and associated material hinges 59g (including pick-device guard area) can be lowered allowing for better stack-ability potential.

FIG. 60 is a section front-view of utensil-portion 53 configured as an angled-flosser.

FIG. 61 is a section front-view of utensil-portion 61 configured as a spoon.

FIG. 62 is a section front-view of utensil-portion 62 configured as a knife.

FIG. 63 is a section front-view of utensil-portion 63 configured as a fork.

FIG. 64 is a section front-view of utensil-portion 64 configured as a spork.

FIG. 65 is a section front-view of utensil-portion 65 configured as a stirring rod, stirring rod can double as a handle.

FIG. 66 is a section front-view of utensil-portion 66 configured with a top-segment 66″ and a bottom-segment 66′, separated by rotational features which include material hinges 66g, neck 66e and clearance area 66d. When top-segment 66″ is bent-away relative to bottom-segment 66′ rotational energy is stored in material hinges 66g, as similarly described in FIG. 59. Clearance area 66d and neck 66e are made and arranged so as to allow for the rotational energy generated during a user initiated top-segment 66″ to bottom-segment 66′ bend-away event to be focused into material hinges 66g, where upon user release or disengagement of a bend-away event the stored rotational energy returns the top-segment 66″relative to bottom-segment 66′ back to a nearly if not complete initial start position.

FIG. 67 is a section front-view of utensil-portion 67 configured with a top-segment 67″ and a bottom-segment 67′, separated by a displaceable score-line 67g. In a bend-away embodiment, when top-segment 67″ (along with any top section attached utensil-portion) is bent-away relative to bottom-segment 67′ (along with any bottom section end-portion) the pick-device 67b is rotated up and exposed for use.

FIG. 68 is a section front-view of utensil-portion 68 configured with a top-segment 68″ and a bottom-segment 68′, separated by rotational features which include material hinges 68g, neck 68e and clearance area 68d. Similar to FIG. 66 when top-segment 68″ is bent-away relative to bottom-segment 68′ rotational energy is stored in material hinges 68g. Clearance area 68d and neck 68e are made and arranged so as to allow for the rotational energy generated during a user initiated top-segment 68″ to bottom-segment 68′ bend-away event to be focused into material hinges 68g, the bend-away action rotating pick-device 68b thusly exposing it for use, similar to FIG. 67.

FIG. 69 is a section front-view of utensil-portion 69 configured with a pick-device 69b, top-segment 69″ and a bottom-segment 69′, separated by a displaceable score-line 69g. In a bend-away embodiment and similarly to FIG. 67, when top-segment 69″ is bent-away relative to bottom-segment 69′ the pick-device 69b is rotated up exposing it for use.

FIG. 70 is a section front-view of utensil-portion 70 configured with pick-device 70b which is displaceable about score-line 70g.

FIG. 71 is a section front-view of utensil-portion 71 configured with pick-device 71b which is displaceable about score-line 71g.

FIG. 72 is a section front-view of utensil-portion 72 configured with pick-device 72b which is displaceable about score-line 72g. Similar to the pick-device 59b related material hinges 59g depicted in FIG. 59, score-lines 72g can be omitted turning the score-lines 72g region into a material hinges about which rotational bend-away occurs.

FIG. 73 is a section front-view of utensil-portion 73 configured with pick-device 73b which is displaceable about score-line 73g, (Dual pick) pick-device 73b. Similar to the pick-device 59b related material hinges 59g depicted in FIG. 59, score-lines 73g can be omitted turning the score-lines 73g region into a material hinges about which rotational bend-away occurs.

FIG. 74 is a section front-view of utensil-portion 74 configured with a tab-grip integrated pick-device 74b which is displaceable about score-line 74g, pick-device 74b configured with attachment regions for two pick-devices. Similar to the pick-device 59b related material hinges 59g depicted in FIG. 59, score-lines 74g can be omitted turning the score-lines 74g region into a material hinges about which rotational bend-away occurs.

FIG. 75 is a section front-view of utensil-portion 75 configured with a tab-grip integrated pick-device 75b which is displaceable about score-line 75g.

FIG. 76 is a section front-view of utensil-portion 76 configured with a tab-grip integrated pick-device 76b which is displaceable about score-lines 76g.

FIG. 77 is a section front-view of utensil-portion 77 configured pick-device 77b which is displaceable about score-line 77g, pick-device 77b upon deployment rotating about material hinges 77g during a bend-away event, similar to the pick-device 59b related material hinges 59g depicted in FIG. 59. Material hinges 77g could incorporate score-lines which would enable snap-away removal of pick-device 77b and/or utensil-portion material could be brittle and simple break-off at the material hinge location.

FIG. 78 is a section front-view of utensil-portion 78 configured with a tab-grip integrated pick-device 78b which is displaceable about material hinges 78g, pick-device 78b made to rotate about material hinges 78g during a bend-away event, similar to FIG. 77. Material hinges 78g could incorporate score-lines which would enable snap-away removal of pick-device 78b and/or utensil-portion material could be brittle and simple break-off at the material hinge location.

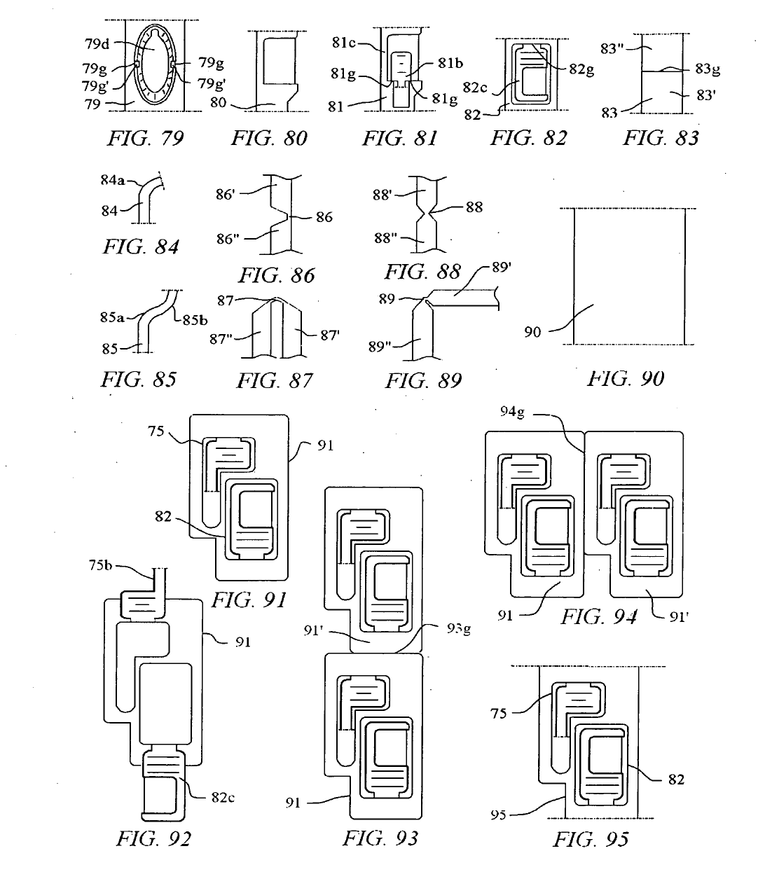

FIG. 79 is a section front-view of utensil-portion 79 configured with a removably, attached burstable container 79d similar to those depicted in FIGS. 16-20. Burstable container 79d is initially held by snap-off clips 79g′, snap-off clips 79g′ are removably attached to utensil-portion 79 at score-lines 79g where burstable container 79d is made available for snap-off deployment by user. Preferably burstable container 79d is molded about snap-off clips 79g during the molding process. The detachable burstable container 79d design is not limited to the FIG. 79 depicted attachment method and can be attached to utensil-portion 79 in a variety of other ways.

FIG. 80 is a section front-view of utensil-portion 80 configured as a vertical-flosser 80.

FIG. 81 is a section front-view of utensil-portion 81 configured with a vertical-flosser 81c and tabbed pick-device 81b, tab located in the vertical-flosser 81 flosser opening with pick-device 81b being snap-off removable at score-lines 81g.

FIG. 82 is a section front-view of utensil-portion 82 configured with a flosser 82 which is displaceable about score-line 82g. Score-line 82g in reference to flosser 82c can be configured at any area located within utensil-portion 82 opening. The orientation of the flosser head is not restricted to vertical as shown and could instead be horizontal or angled.

FIG. 83 is a section front-view of utensil-portion 83 configured with top-segment 83″ and bottom-segment 83′, displaceably separated by score-line 83g.

FIG. 84 is a section side-view of utensil-portion 84 configured with a permanent-bend 84a. Permanent-bend 84a can vary in arrangement and design, also as an alternative additional bends can be added to utensil-portion 84.

FIG. 85 is a section side-view of utensil-portion 85 configured with a permanent-bend 85a and a permanent-bend 85b. Permanent-bends 85a and 85b can vary in arrangement and design, also as an alternative additional permanent bends can be added to utensil-portion 85.

FIG. 86 is a cut-away side-view of one of the many possible displacement score-line 86 designs defined previously; wherein segment 86′ is separated from segment 86″ by score-line 86; and wherein segment 86′ in reference to segment 86″ is in an initial/straight position-a. In a bend-away configuration, the score-line 86 design allows for bend-away of segment 86′ in reference to segment 86″ up to 90 degrees in one direction and up to 180 degrees in the opposite direction without accounting for material deflection. In a snap-away configuration, segment 86′ can be snapped-away from segment 86″, at score-line 86. FIGS. 86-89 score-line related angles, cut depths and design configurations can be modified so as to allow for various bend-away radiuses and required bend-away (radial) forces. Furthermore the hygienic-utensil material can also allow for additional bend-away caused by material deflection, allowing up to near (if not total) 180 degree bend-away rotation of score-line separated elements in both directions.

FIG. 87 is a cut-away side-view of FIG. 86 wherein segment 86′ is bent-away 180 degrees in reference to segment 86″, about score-line 86.

FIG. 88 is a cut-away side-view of a displaceable score-line 88 design defined previously; wherein segment 88′ is separated from segment 88″ by score-line 88; and wherein segment 88′ in reference to segment 88″ is in an initial/straight position-a. In a bend-away configuration, score-line 88 will allow bend-away of section 88′ in reference to segment 88″ equal-distant in both directions with the bend-away angle being determined by score-line design and material (deflection) properties. In a snap-away configuration, segment 88′ can be snapped-away from segment 88″, at score-line 88. Score-line designs as referenced in this specification can function as a living-hinge, wherein the living-hinge would allow for bend-away flexion of score-line separated elements (sections), a living-hinge design can be made and arranged in various ways so as to be more or less stiff and/or to allow for more or less rotational bend-away.

FIG. 89 is a cutaway side-view of FIG. 88 wherein segment 88′ is bent-away in reference to segment 88″, about score-line 88.

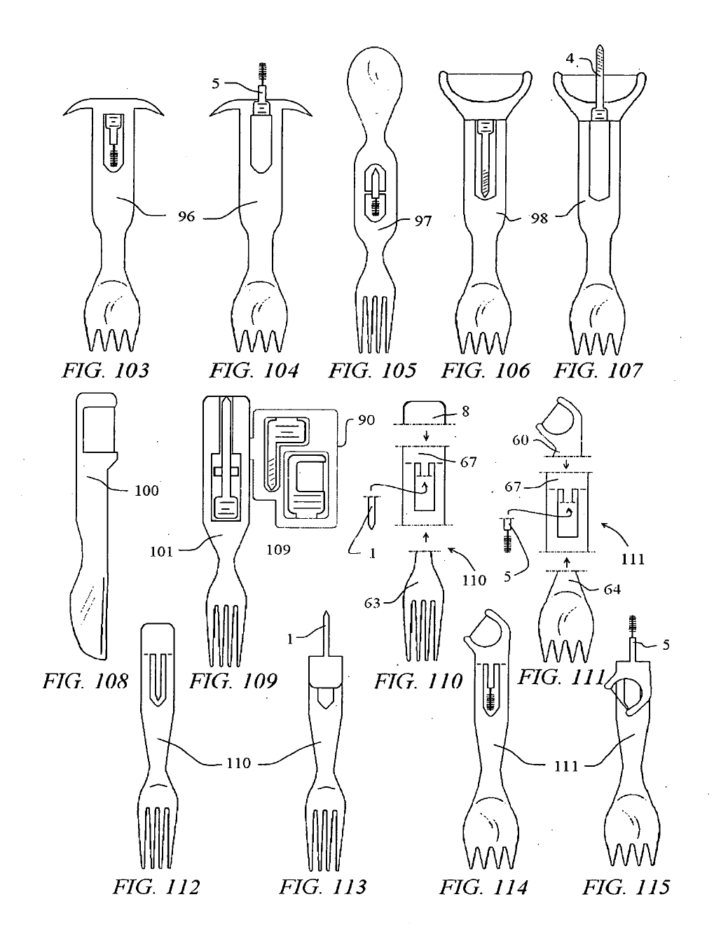

FIG. 90 is a section front-view of a utensil-panel 90. A standalone utensil-panel configured with one device is considered to be a hygienic-utensil. A utensil-panel can be configured with at least one embedded utensil-portion as seen in FIGS. 91-95, 101-102 and 130-13; embedded utensil-portions are not limited there arrangement, location and/or orientation within the utensil-panel. A utensil-panel can be presented in a standalone configuration or it can be displaceably and/or permanently attached to at least one other utensil-panel, FIGS. 93-94 show an example of two displaceably attached utensil panels. A utensil-panel can vary in configuration, size and shape. A utensil-panel can have at least one internally attached (sub) utensil-panel, hygienic-utensil (as seen in FIG. 102) and/or utensil-portion (also as seen in FIG. 102). Utensil-panels can be permanently and/or displaceably attached to other utensil panels, utensil-portions and/or utensil-facilities. All though there are two section-match locations shown in FIG. 90 the number/arrangement of section-match locations is not limited but rather design dependent.

FIG. 91 is a front-view of a standalone-utensil-panel 91 embedded with a FIG. 75 utensil-portion 75 and FIG. 82 utensil-portion 82.

FIG. 92 depicts a front-view of FIG. 91 utensil-panel 91 with both the FIG. 75 pick-device 75b and the FIG. 82 82c deployed ready for use.

FIG. 93 depicts a front-view of score-line 93g displaceably attached and vertically joined FIG. 91 utensil-panels 91 and 91′.

FIG. 94 depicts a front-view of score-line 94g displaceably attached and horizontally joined FIG. 91 utensil-panels 91 and 91′. Utensil-panels can be joined together at various locations and in various configurations.

FIG. 95 depicts a section front-view of utensil-panel 95 embedded with utensil-portions 75 and 82. There are (2) section-line locations where utensil-panel 94 could be sectioned-matched with other utensil-portions, utensil facilities and/or utensil-panels.

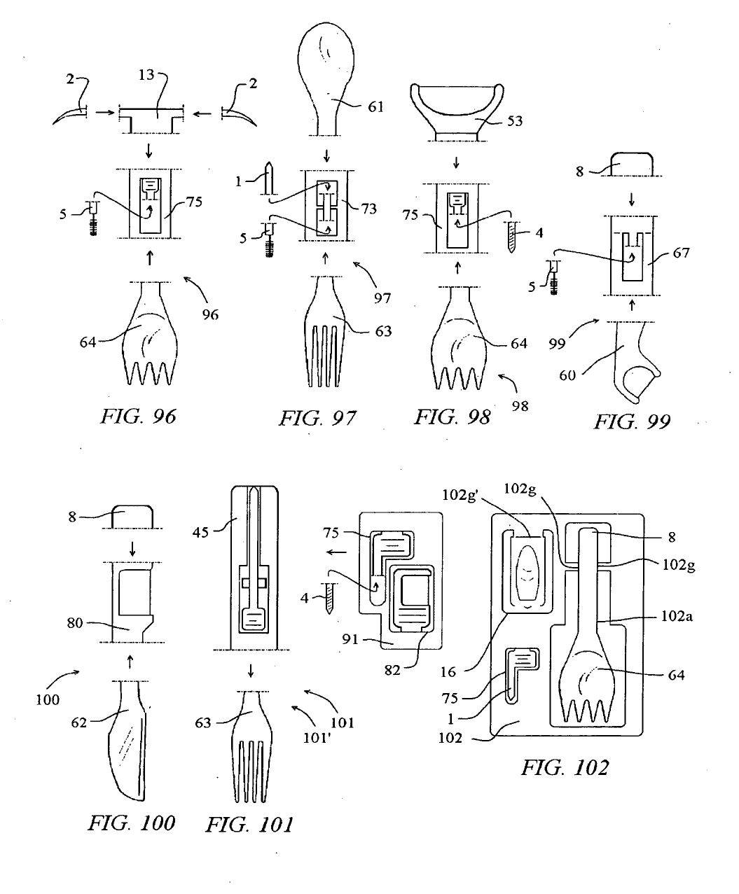

FIG. 96 depicts an exploded section-assembly front-view of a section-matched (eating oriented) hygienic-utensil 96 comprising FIG. 2 pick-device 2 (count-two); FIG. 5 pick-device 5; FIG. 13 utensil-portion 13; FIG. 75 utensil-portion 75 and FIG. 64 utensil-portion 64. In FIGS. 96-100 as with any section-matched hygienic-utensil elements it is to be understood that the section-lines where section-matching occurs between hygienic-utensil elements is shown for reference purposes only and that section-matched locations between hygienic-utensil elements can vary in mating configuration, location, dimension, variation and design. Hygienic-utensils are generally formed as a single piece molded plastic part. Alternative embodiments for hygienic-utensil 96 made available by replacing: utensil-portion 13 with one of the utensil-portions 6-15, 47-50; utensil-portion 75 with one of the utensil-portions 66-83; utensil-portion 64 with one of the utensil-portions 8, 16, 21-22, 25-30, 36, 43, 51-65; and/or any of the pick devices intended for section match to a corresponding utensil-portion.

FIG. 97 depicts an exploded section-assembly front-view of a section-matched (eating oriented) hygienic-utensil 97 comprising FIG. 61 utensil-portion 61; FIG. 1 pick-device 1; FIG. 5 pick-device 5; FIG. 73 utensil-portion 73 and FIG. 63 utensil-portion 63. Alternative embodiments for hygienic-utensil 97 made available by replacing: either utensil-portion 61 or 63 with one of utensil-portions 8, 16, 21-22, 25-30, 36, 43, 51-65; utensil-portion 73 with one of the utensil-portions 66-83; and/or any of the pick devices intended for section match to a corresponding utensil-portion.

FIG. 98 depicts an exploded section-assembly front-view of a section-matched (eating oriented) hygienic-utensil 98 comprising FIG. 53 utensil-portion 53; FIG. 4 pick-device 4; FIG. 75 utensil-portion 75; and FIG. 64 utensil-portion 64. Alternative embodiments for hygienic-utensil 98 made available by replacing: either utensil-portion 53 or 64 with one of the utensil-portions 8, 16, 21-22, 25-30, 36, 43, 51-65; utensil-portion 75 with one of the utensil-portions 66-83; and/or any of the pick devices intended for section match to a corresponding utensil-portion.

FIG. 99 depicts an exploded section-assembly front-view of a section-matched hygienic-utensil 99 comprising FIG. 8 utensil-portion 8, FIG. 67 utensil-portion 67 and FIG. 60 utensil-portion 21 60. Alternative embodiments for hygienic-utensil 99 made available by replacing: either utensil-portion 53 or 21 with one of the utensil-portions 8, 16, 21-22, 25-30, 36, 43, 51-65; utensil-portion 75 with one of the utensil-portions 66-83; and/or any of the pick devices intended for section match to a corresponding utensil-portion.

FIG. 100 depicts an exploded section-assembly front-view of a section-matched hygienic-utensil 100 comprising FIG. 8 utensil-portion-8; FIG. 80 utensil-portion 80 and FIG. 62 utensil-portion 62. Alternative embodiments for hygienic-utensil 100 made available by replacing: utensil-portion 8 with one of the utensil-portions 6-15, 47-50; utensil-portion 62 with one of the utensil-portions 8, 16, 21-22, 25-30, 36, 43, 51-65; utensil-portion 80 with one of the utensil-portions 66-83; and/or any of the pick devices intended for section match to a corresponding utensil-portion.

FIG. 101 depicts an exploded section-assembly front-view of a section-matched (eating oriented) hygienic-utensil 101 comprised of hygienic-utensil 101′ and utensil-panel 91. Hygienic-utensil 101′ is comprised of FIG. 45 utensil-portion 43 (with pick-device 39, section-matched with pick-device 1) and FIG. 63 utensil-portion 63. Hygienic-utensil 101′ is intended for attachment with utensil-panel 91. Utensil-portion 75 is shown as being section-matched with FIG. 4 pick-device 4 at pick-device 75b section-line location. Utensil-panel 91 is intended for attachment to hygienic-utensil 101′ at a practical/applicable attachment region about a score-line 109 (as shown in FIG. 109); score-line 109 allows for snap-off removal of utensil-panel 91; where upon snap-off removal of utensil-panel 91, excess material at the snap-off region remains attached with utensil-panel 91 leaving the hygienic-utensil 101′ score-line interface bur-free. Alternative embodiments of hygienic-utensil 101′ are made available replacing: either utensil-portion 45 or 63 with one of the utensil-portions 8, 16, 21-22, 25-30, 36, 43, 51-65; and/or any of the pick devices intended for section match to a corresponding utensil-portion. Many more embodiments of hygienic-utensil 101 are made available by combining the number of alternative embodiment options related with hygienic-utensil 101′ with the numerous embodiment options for utensil-panel 91. Many embodiments of utensil-panel 91 are made available by changing the number/type/arrangement of embedded/attached utensil-portions/utensil-panels/hygienic-utensils and combinations/variations thereof, of utensil-panel 91.

As supported in FIG. 90 utensil-panel description, FIG. 102 depicts a front-view of a (eating oriented) utensil-panel 102 (also considered a hygienic-utensil since it is a standalone utensil-panel configured with at least one hygienic-device) configured with an embedded FIG. 75 utensil-portion 75; an internally attached FIG. 16 utensil-portion 16, removable detachable at score-line 102g′; and an internally and removably attached (eating oriented) hygienic-utensil 102a. Hygienic-utensil 102a is section-match assembled from FIG. 8 utensil-portion 8 and FIG. 64 utensil-portion 64, with hygienic-utensil 102a removably attached to utensil-panel 102 at score-lines 102g. Many embodiments of utensil-panel 102 are made available by changing the number/type/arrangement of embedded/attached utensil-portions/utensil-panels/hygienic-utensils and combinations/variations thereof, of hygienic-utensil 102.

FIG. 103 depicts a front-view of FIG. 96 section-matched (eating oriented) hygienic-utensil 96.

FIG. 104 depicts a front-view of FIG. 103 section-matched (eating oriented) hygienic-utensil 96 with interdental-brush 5 (bend-away) deployed and ready for use.

FIG. 105 depicts a front-view of FIG. 97 section-matched (eating oriented) hygienic-utensil 97.

FIG. 106 depicts a front-view of FIG. 98 section-matched (eating oriented) hygienic-utensil 98.

FIG. 107 depicts a front-view of FIG. 106 section-matched (eating oriented) hygienic-utensil 98 with pick-device 4 (bend-away) deployed for use.

FIG. 108 depicts a front-view of FIG. 100 section-matched (eating oriented) hygienic-utensil 100 configured with a vertical-flosser.

FIG. 109 depicts a front-view of FIG. 101 section-matched (eating oriented) hygienic-utensil 101 that is displaceably attached to utensil-panel 90 at score-line 109.

FIG. 110 depicts an exploded section-assembly front-view of a section-matched (eating oriented) hygienic-utensil 110 comprising FIG. 8 utensil-portion 8; FIG. 1 pick-device 1; FIG. 67 utensil-portion 67; and FIG. 63 utensil-portion 63. Alternative embodiments for hygienic-utensil 110 made available by replacing: either utensil-portion 8 or 63 with one of the utensil-portions 8, 16, 21-22, 25-30, 36, 43, 51-65; utensil-portion 67 with one of the utensil-portions 66-83; and/or any of the pick devices intended for section match to a corresponding utensil-portion.

FIG. 111 depicts an exploded section-assembly front-view of a section-matched (eating oriented) hygienic-utensil 111 comprising FIG. 60 utensil-portion 60; FIG. 5 pick-device 5; FIG. 67 utensil-portion 67; and FIG. 64 utensil-portion 64. Alternative embodiments for hygienic-utensil 111 made available by replacing: either utensil-portion 60 or 64 with one of the utensil-portions 8, 16, 21-22, 25-30, 36, 43, 51-65; utensil-portion 67 with one of the utensil-portions 66-83; and/or any of the pick devices intended for section match to a corresponding utensil-portion.

FIG. 112 depicts a front-view of FIG. 110 section-matched (eating oriented) hygienic-utensil 110.

FIG. 113 depicts a front-view of FIG. 112 section-matched (eating oriented) hygienic-utensil 110 with pick-device 1 (bend-away) deployed for use.

FIG. 114 depicts a front-view of FIG. 111 section-matched (eating oriented) hygienic-utensil 111.

FIG. 115 depicts a front-view of FIG. 114 section-matched (eating oriented) hygienic-utensil 110 with interdental-brush 5 (bend-away) deployed for use.

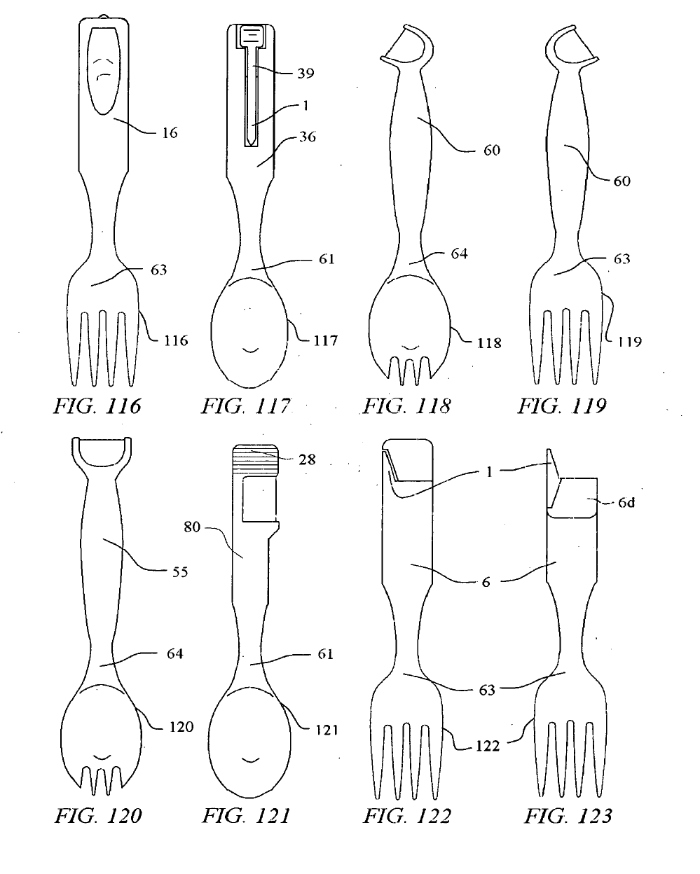

FIG. 116 depicts a section-matched (eating oriented) hygienic-utensil 116 comprised of FIG. 16 utensil-portion 16; and FIG. 63 utensil-portion 63. Alternative embodiments for hygienic-utensil 116 made available by replacing: either utensil-portion 16 or 63 with one of the utensil-portions 8, 16, 21-22, 25-30, 36, 43, 51-65.

FIG. 117 depicts a section-matched (eating oriented) hygienic-utensil 117 comprised of FIG. 36 utensil-portion 36 (pick-device 39 section-matched with pick 1); and FIG. 61 utensil-portion 61. Alternative embodiments for hygienic-utensil 117 are made available by replacing: either utensil-portion 36 or 117 with one of the utensil-portions 8, 16, 21-22, 25-30, 36, 43, 51-65; and/or any of the pick devices intended for section match to a corresponding utensil-portion.

FIG. 118 depicts a section-matched (eating oriented) hygienic-utensil 118 comprised of FIG. 60 utensil-portion 60 and FIG. 64 utensil-portion 64. Alternative embodiments for hygienic-utensil 118 are made available by replacing: either utensil-portion 60 or 64 with one of the utensil-portions 8, 16, 21-22, 25-30, 36, 43, 51-65.

FIG. 119 depicts a section-matched (eating oriented) hygienic-utensil 119 comprised of FIG. 60 utensil-portion 60 (in an alternative orientation to that shown in FIG. 118) and FIG. 63 utensil-portion 63. Alternative embodiments for hygienic-utensil 1 are made available by replacing: either utensil-portion 60 or 63 with one of the utensil-portions 8, 16, 21-22, 25-30, 36, 43, 51-65.

FIG. 120 depicts a section-matched (eating oriented) hygienic-utensil 120 comprised of FIG. 55 utensil-portion 55 and FIG. 64 utensil-portion 64. Alternative embodiments for hygienic-utensil 120 are made available by replacing: either utensil-portion 55 or 64 with one of the utensil-portions 8, 16, 21-22, 25-30, 36, 43, 51-65.

FIG. 121 depicts a section-matched hygienic-utensil 121 comprised of FIG. 28 utensil-portion 80 and FIG. 61 utensil-portion 61. Alternative embodiments for hygienic-utensil 121 are made available by replacing: either utensil-portion 28 or 61 with one of the utensil-portions 8, 16, 21-22, 25-30, 36, 43, 51-65; utensil-portion 80 with one of the utensil-portions 66-83.

FIG. 122 depicts a section-matched (eating oriented) hygienic-utensil 122 comprised of FIG. 6 utensil-portion 6; FIG. 1 pick-device 1 and FIG. 63 utensil-portion 63. Alternative embodiments for hygienic-utensil 122 are made available by replacing: either utensil-portion 6 or 63 with one of the utensil-portions 8, 16, 21-22, 25-30, 36, 43, 51-65; and/or any of the pick devices intended for section match to a corresponding utensil-portion.

FIG. 123 depicts a front-view of FIG. 122 section-matched (eating oriented) hygienic-utensil 122 with guard-tab 6d displaced exposing pick-device 1 ready for use.

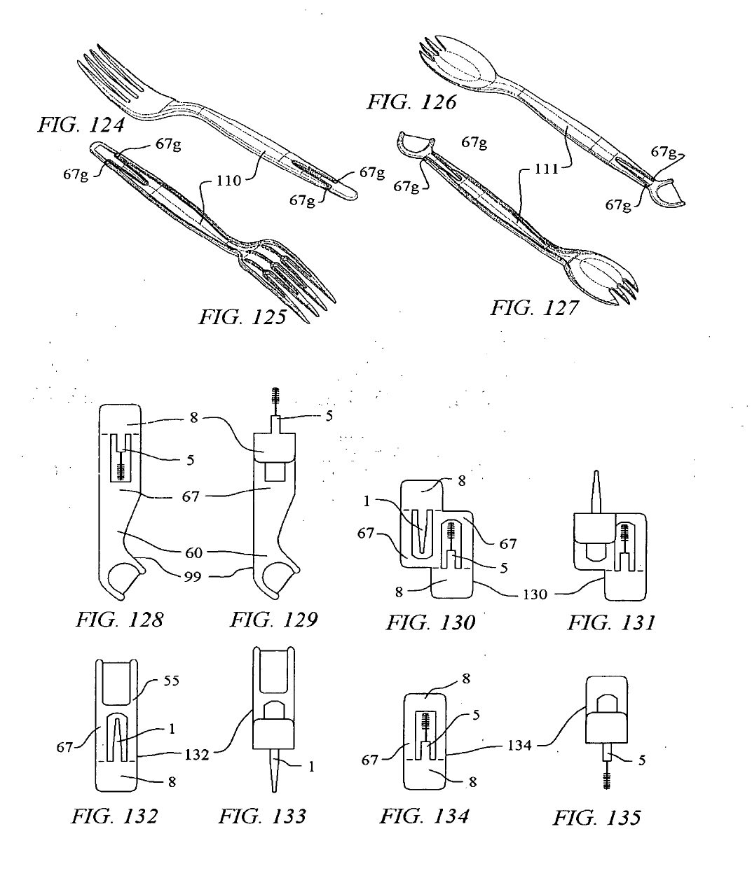

FIG. 124 depicts a top isometric-view (commercial depiction) of FIG. 110 (eating oriented) hygienic-utensil 110 with FIG. 67 score-lines 67g. Score-lines 67g are similar to FIG. 88 score-line 88 and allow for pick-device 67d to be bent-away (for deployment) up to approximately 180 degrees in both directions.

FIG. 125 depicts a bottom isometric-view (commercial depiction) of FIG. 124 (eating oriented) hygienic-utensil 110 and FIG. 67 score-lines 67g.

FIG. 126 depicts a top isometric-view (commercial depiction) of FIG. 111 (eating oriented) hygienic-utensil 111 with FIG. 67 score-lines 67g. Score-lines 67g are similar to FIG. 88 score-line 88 and allow for pick-device 67d to be bent-away (for deployment) up to approximately 180 degrees in both directions.

FIG. 127 depicts a bottom isometric-view (commercial depiction) of FIG. 126 (eating oriented) hygienic-utensil 111 and FIG. 67 score-lines 67g.

FIG. 128 depicts a section-matched hygienic-utensil 99 comprised of FIG. 8 utensil-portion 8; FIG. 5 pick-device 5; FIG. 67 utensil-portion 67 and FIG. 60 utensil-portion 60. Alternative embodiments for hygienic-utensil 99 are made available by replacing: either utensil-portion 8 or 60 with one of the utensil-portions 8, 16, 21-22, 25-30, 36, 43, 51-65; utensil-portion 67 with one of the utensil-portions 66-83; and/or any of the pick devices intended for section match to a corresponding utensil-portion.

FIG. 129 depicts a front-view of FIG. 128 section-matched hygienic-utensil 99 with pick-device 5 (bend-away) deployed for use.

FIG. 130 depicts a front-view of a utensil-panel 130 (also considered a hygienic-utensil since it is a standalone utensil-panel configured with at least one hygienic-device) configured with two embedded FIG. 67 utensil-portions 67, both utensil-portions configured with utensil-portion 8 with one utensil-portion further configured with FIG. 1 pick-device 1 and the other with FIG. 5 pick-device 3. Many embodiments of utensil-panel 130 are made available by changing the number/type/arrangement of embedded/attached utensil-portions/utensil-panels/hygienic utensils and combinations/variations thereof; of hygienic-utensil 130.

FIG. 131 depicts a front-view of FIG. 130 section-matched utensil-panel 130 with pick-device 1 (bend-away) deployed for use.

FIG. 132 depicts a section-matched hygienic-utensil 132 comprised of FIG. 8 utensil-portion 8; FIG. 1 pick-device 1; FIG. 67 utensil-portion 67 and FIG. 55 utensil-portion 55. Alternative embodiments for hygienic-utensil 132 are made available by replacing: either utensil-portion 8 or 55 with one of the utensil-portions 8, 16, 21-22, 25-30, 36, 43, 51-65; utensil-portion 67 with one of the utensil-portions 66-83; and/or any of the pick devices intended for section match to a corresponding utensil-portion.

FIG. 133 depicts a front-view of FIG. 132 section-matched utensil-panel 132 with pick-device 1 (bend-away) deployed for use.

FIG. 134 depicts a section-matched hygienic-utensil 134 comprised of two FIG. 8 utensil-portions 8; FIG. 67 utensil-portion 67 and FIG. 5 pick-device 5. Alternative embodiments for hygienic-utensil 134 are made available by replacing: either utensil-portions 8 with one of the utensil-portions 8, 16, 21-22, 25-30, 36, 43, 51-65; utensil-portion 67 with one of the utensil-portions 66-83; and/or any of the pick devices intended for section match to a corresponding utensil-portion.

FIG. 135 depicts a front-view of FIG. 134 section-matched utensil-panel 134 with pick-device 1 (bend-away) deployed for use.

It is understood that the above described hygienic-utensil elements (including pick-devices, utensil-portions and utensil-panels) can vary in arrangement, shape, size, orientation and element-locations so as not to depart from the utensil-portion originally intended functionality. As depicted in FIGS. 95-97, 99-100, 102-129 utensil-portions and/or utensil-panels either individually and/or collectively section-matched together can double or function as a hygienic-utensil handle, many utensil-portions used throughout this specification are elongated so as to depict a longer handle.

Hygienic-utensil elements in a given hygienic-utensil could be comprised of blended plastics, whereas certain region locations, score-line regions in particular could be comprised of more rigid plastic so as to allow for snap-away displacement around said score-line while a different score-line located in another region could be comprised of a more resilient plastic so as to allow for bend-away and/or bend-away/snap-away displacement around said (different) score-line region. Various plastics could also be used to provide different structural characteristics to various hygienic-utensil elements located in said hygienic-utensil. Some figure examples of where blended plastics could be used is depicted in FIGS. 92-94, 100; in these examples the hygienic-utensil to hygienic-utensil displaceable score-line regions could comprise of a more rigid plastic so as to allow snap-off separation, while the utensil-portion (device) related score-line regions could comprise of a more resilient plastic so as to allow for bend-away deployment and use of the devices without separation from said utensil-portion.

As an alternative to hygienic-utensil elements containing flossers complete with an integrated length of dental-floss, a double-head flosser design complete with two individual flosser regions, each configured with a length of dental-floss could instead be used. Single-flosser region designs could alternatively contain multiple lengths of dental-floss, facilitating better cleaning action and providing the addition of back-up floss.

Fully guarded device designs (as depicted in FIGS. 71-78) could have a thumb/finger access area or indention incorporated into the hygienic-utensil element in such a way as to allow a user to initiate deployment of a (pick) device, by pressing the indented thumb/finger access region.

As an alternative to the oral-brushes (as depicted in FIGS. 22-25 and 29) being integrated on the face of the utensil-portion the oral-brush could instead be integrated onto the side or perimeter of the utensil-portion.

FIGS. 23-27 and 29 utensil-portions are configured with a type of oral brush. The oral brush could be any brush that can be used orally, including but is not limited to bristle-type brushes, interdental-type brushes, pad/fabricate-type of brushes and combinations thereof. The oral brush can be directly molded into the utensil-portion and/or applied to a utensil-portion in a secondary assembly application. Bristle-type oral brushes could vary in such areas as, but not limited to, count, arrangement, stiffness, color, width, length, material, attachment method to base and combinations thereof. The portion of the utensil-portion that contains either the tongue cleaner and/or the oral brush could be made with at least one permanent bend or made flexible so as to make accessing teeth, tongue and other parts of the mouth easier and more convenient. The oral-brush of a type brushing pad (as depicted in FIGS. 22-24, 26) could be fabric and/or or sponge-like-substance that would have enough give to allow conformity to the teeth surfaces during a brushing action; the brushing pad would be resilient when wet and used in combination with (pre-defined) oral pastes, gels, powders, creams, liquids and combinations thereof; the brushing pad (floss in flossing devices and other oral brushes) could be infused with any number of oral-care products i.e. fluoride, toothpaste (power form); the brushing pad would be configured with elements that would initiate and remove germs, plaque and debris from teeth, tongue and other oral features without causing adverse damage.

FIGS. 4 and 5 interdental devices would preferably be made sufficiently thin and abrasive as to enable cleaning and debris removal between adjacent teeth.

When designing/making the burstable containers depicted in FIGS. 16-20 and 79 pressure-deltas and the corrosive nature of any substance contained in the burstable containers should be considered when selecting and filling the associated burstable pouch container. The burstable container would ideally already be manufactured as a standalone product and made available to be incorporated into the utensil-portion during the utensil-portion molding process. The burstable container could be sold as a standalone unit. The cross-sectional shape/size and general configuration of the burstable pouch container sealed portion region (substance exit region) can vary as to allow for idea exiting/exhaust of the container substance upon a user initiated burst. Alternatively to a, generally one-time use, burstable container being incorporated into a utensil-portion a reseal-able/reusable and/or a differently configured one-time use only type of container could instead be used. A container could hold things from oral hygienic types of substances i.e. mouthwash, oral-liquids, oral gels, oral powders and toothpaste; to food related substances i.e. condiments such as ketchup, mustard, mayonnaise; to oral hygienic devices such as a toothpick and/or dental-floss; to hygienic related items in general such as tissue (napkins), floss and wipes. Instead of containers being incorporated into a hygienic-utensil (element) they could be directly attached, either permanently, removably or displaceably; or optionally bundled wrapped to/with a hygienic-utensil (element). The burstable pouch could be manufacturing filled by injection the substance into an already sealed pouch and the heat sealing the injection site.

The hygienic-utensil elements especially those containing oral-brushes, flossers and tongue-cleaners could incorporate contouring and/or permanent bends that would make deployment of these oral-hygienic devices more convenient for a user to access the different regions and oral features of the mouth.

Supplemental items such as dental floss, tissue paper or mouth wash could be provided either separately, stored within or attached to a hygienic-utensil or a hygienic-utensil element in some manner, optionally bundle-wrapped. Hygienic-utensils could be individually wrapped or bundle wrapped with other hygienic-utensil elements and/or other hygienic-utensil element complimentary items.

While the invention is directed primarily to an unfulfilled need and expected demand in conjunction with disposable plastic oral-hygienic hygienic-utensils which are likely to be popular at picnics and other social or public eating events where regular oral hygienic facilities are unavailable, the invention could be practiced in conjunction with more permanent types hygienic-utensil elements intended for more general and regular use. The materials used to make hygienic-utensil elements could be metal, wood, composites, fabrics or any material that can provide the desired structural-support, break-away and/or bend-back functionality inherit to most of the hygienic-utensil related embodiments. As an alternative to the generally one-piece construction for an oral hygienic hygienic-utensil, it could be made from a plurality of parts joined by fastenings such as welding, mechanical fasteners and/or adhesives, i.e. score-line/hinge locations and pick devices could be made from a different material then the rest of the associated hygienic-utensil, this items could be mold incorporated into the hygienic-utensil.

Hygienic-utensil elements could include but are not limited to such features as ribbed-supports and similar structural/cosmetic elements.

Extreme sharpness at the working end of certain pick-devices should avoid having extreme sharpness at the working end so as to be avoided as hazardous; instead the point should be made slightly rounded, sufficient to avoid injury, while still shaped optimally to provide effective cleaning capability.

For utensil-portions such as those shown in FIGS. 9-15 where a pick-device extends unguarded, a lid or cap of some kind could be included for use as a cover or sheath.

The invention may be embodied and practiced in other specific forms without departing from the spirit and essential characteristics thereof. The present embodiments are therefore to be considered in all respects as illustrative and not restrictive, the scope of the invention being indicated by the appended claims rather than by the foregoing description; and all variations, substitutions and changes which come within the meaning and range of equivalency of the claims are therefore intended to be embraced therein.

What is claimed is:

1. A combination oral hygienic-utensil, comprising:
a utensil; and
at least one device of a type selected from a group consisting of flossers, picks, interdental picks, interdental brushes, tongue cleaners, oral brushes, containers, spoons, knives, forks, sporks, stirring rods, handles, tongs, chopsticks and combinations thereof made in conjunction with said utensil.

2. The combination oral hygienic-utensil as defined in claim 1 whereas at least one of said devices is displaceably integrated with said utensil.

3. The combination oral hygienic-utensil as defined in claim 1 whereas at least one of said devices is permanently integrated with said utensil.

4. The combination oral hygienic-utensil as defined in claim 2 whereas at least one of said displaceably integrated devices is removably integrated with said utensil.

5. The combination oral hygienic-utensil as defined in claim 2 whereas
at least one of said displaceably integrated devices is intended for user deployment and use while remaining integrated with said utensil.

6. The combination oral hygienic-utensil as defined in claim 2; whereas
at least one of said displaceably integrated devices is removably integrated with said utensil; and whereas
at least another one of said displaceably integrated devices is intended for user deployment and use while remaining integrated to with said utensil.

7. The combination oral hygienic-utensil as defined in claim 1; whereas
at least one of said devices is displaceably integrated with said utensil; and whereas
at least one of said devices is permanently integrated with said utensil.

8. The combination oral hygienic-utensil as defined in claim 7 whereas at least one of said displaceably integrated devices is intended for user deployment and use while remaining integrated with said utensil.

9. The combination oral hygienic-utensil as defined in claim 7 whereas at least one of said and displaceably integrated devices is removably integrated with said utensil.

10. The combination oral hygienic-utensil as defined in claim 1 whereas at least one of said devices is initially guarded by at least one portion of displaceably attached protective material.

11. The combination oral hygienic-utensil as defined in claim 10 whereas said attached protective material is said utensil material.

12. The combination oral hygienic-utensil as defined in claim 11 whereas said protective material is bent away to expose said device, protective material remaining attached to sail utensil.

13. The combination oral hygienic-utensil as defined in claim 1 wherein at least one of said devices is both removable and reattach-able to said utensil.

14. The combination oral hygienic-utensil as defined in claim 10 wherein said utensil is an eating utensil.

15. The combination oral hygienic-utensil as defined in claim 13 wherein said utensil is an eating utensil.

16. The combination oral hygienic-utensil as defined in claim 1 wherein said utensil is an eating utensil.

17. The combination oral hygienic-utensil as defined in claim 1 wherein said utensil is selected from a group consisting of a flosser, tongue cleaner, oral brush and combinations thereof.

18. The combination oral hygienic-utensil as defined in claim 1 wherein said utensil is selected from a group consisting of a flosser, tongue cleaner, oral brush, fork, spoon, knife, spork, stirring-rod, handle, tongs, chopsticks and combinations thereof.
